(19) United States
(12) Patent Application Publication
(10) Pub. No.: US 2008/0319568 A1
(43) Pub. Date: Dec. 25, 2008

(54) METHOD AND SYSTEM FOR CREATING ARRAY DEFECT PARETOS USING ELECTRICAL OVERLAY OF BITFAIL MAPS, PHOTO LIMITED YIELD, YIELD, AND AUTO PATTERN RECOGNITION CODE DATA

(75) Inventors: Zachary E. Berndlmaier, Hopewell Junction, NY (US); Jonathan K. Winslow, II, Yorktown Heights, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/766,844

(22) Filed: Jun. 22, 2007

(51) Int. Cl. G06F 19/00

(52) U.S. Cl. 700/110

(57) ABSTRACT

A method for creating defect array paretos for semiconductor manufacturing, the method includes: merging a set of ETPLY data {the electrical overlay of bitfail map (BFM) data with inline photo inspection (PLY) data), and auto pattern recognition code (APRC) failure data to create an electrical failure data set along with a set of inline photo inspection defects that caused electrical failures; merging the APRC failure data with wafer final test (WFT) sort data to delineate array failures that are repairable from array failures that are not repairable for the calculation of kill ratios; wherein the merging of the APRC failure data with the WFT sort data is used to create paretos of APRC codes that are array failures that are not repairable; and wherein the merging of the APRC failure data with the WFT sort data is used to create paretos of APRC codes for semiconductor devices that are repairable at wafer final test.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to semiconductor and integrated circuit device manufacturing processes, and more particularly to a method and system for creating array defect paretos using electrical overlay of bitfail maps, photo limited yield, yield, and auto pattern recognition code data.

2. Description of the Related Art

The manufacture of semiconductor devices is among the most complicated manufacturing processes in the world. The number of steps involved in the semiconductor manufacturing process, as well as semiconductor features measured in nanometers, makes the semiconductor device manufacturing process extremely susceptible to defects and failures. Mature semiconductor device technologies often measure their yields in the 50-75% range, and newer technologies often measure yields in single digits, depending on chip size and complexity.

Wafer manufacturing of semiconductor devices has fixed costs associated with plant and manufacturing equipment, as well as variable costs associated with labor and materials. Therefore, the manufacturing yield of useable semiconductor devices achieved on each wafer has a direct impact on the ability to meet customer commitments, provide a competitive technology and maintain profitability. To this end, semiconductor manufacturing facilities allocate substantial resources towards reducing defects and improving and maximizing yields.

In order to maximize yields of semiconductor devices during the manufacturing process, the characterization engineering community is tasked with detecting defects through electrical and physical signals, quantifying yield impact, and prioritizing defects, so that the manufacturing engineers can prioritize their efforts towards reducing those defects that have the highest yield impact.

One of the major problems, that currently confronts the characterization and manufacturing engineering communities is that there are many different sources of information on defects, all of them having significant benefits and significant drawbacks. Using any one solution provides only part of the answer, and using several of the techniques often provides conflicting answers. Therefore, there is a need to provide a methodology that integrates the sources of defect information into a cohesive unified message that will maximize the benefits of all the defect reporting techniques through out the manufacturing process and minimize their drawbacks.

### SUMMARY OF THE INVENTION

Embodiments of the present invention include a method and system for creating defect array paretos for semiconductor manufacturing, the method includes: merging a set of ETPLY data {the electrical overlay of bitfail map (BFM) data with inline photo inspection (PLY) data), and auto pattern recognition code (APRC) failure data to create an electrical failure data set along with a set of inline photo inspection defects that caused electrical failures; merging the APRC failure data with wafer final test (WFT) sort data to delineate array failures that are repairable from array failures that are not repairable for the calculation of kill ratios; wherein the merging of the APRC failure data with the WFT sort data is used to create paretos of APRC codes that are array failures that are not repairable; and wherein the merging of the APRC failure data with the WFT sort data is used to create paretos of APRC codes for semiconductor devices that are repairable at wafer final test.

A system for creating defect array paretos for semiconductor manufacturing, the system includes: a set of hardware and networking resources; an algorithm implemented on the set of hardware and networking resources; wherein the algorithm merges a set of ETPLY data {the electrical overlay of bitfail map (BFM) data with inline photo inspection (PLY) data), and auto pattern recognition code (APRC) failure data to create an electrical failure data set along with a set of inline photo inspection defects that caused electrical failures; wherein the algorithm merges the APRC failure data with wafer final test (WFT) sort data to delineate array failures that are repairable from array failures that are not repairable for the calculation of kill ratios; wherein the merging of the APRC failure data with the WFT sort data is used to create paretos of APRC codes that are array failures that are not repairable; and wherein the merging of the APRC failure data with the WFT sort data is used to create paretos of APRC codes for semiconductor devices that are repairable at wafer final test.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for creating array defect paretos for semiconductor manufacturing using electrical overlay of bitfail maps, photo limited yield, yield, and auto pattern recognition code data.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram that outlines the methodology for creating array defect paretos using electrical overlay of bitfail maps (ETPLY), photo limited yield (PLY), yield, and auto pattern recognition code (APRC) data according to an embodiment of the invention.

FIG. 2 illustrates a system for implementing embodiments of the invention.

The detailed description explains the preferred embodiments of the invention, together with advantages and features, by way of example with reference to the drawings.

### DETAILED DESCRIPTION

Embodiments of the invention provide a method and system for creating array defect paretos using electrical overlay of bitfail maps (ETPLY), photo limited yield (PLY), yield, and auto pattern recognition code (APRC) data. The methodology of embodiments of the invention integrates ETPLY data [electrical overlay of BFM data (Bitfail Map) with PLY data (Photo Limited Yield—photo inspection)] with APRC data from BFMs with the WFT (Wafer Final Test) results to create a unified defect pareto for semiconductor device arrays, such as static random access memories (SRAM). The advantage of the methodology of embodiments of the invention is that it utilizes the positive aspects of each of these data sets and minimizes the limitations for each technique to create a unified message.

ETPLY data helps to delineate defects that result in chip failures from those that do not. Given array redundancy, this overlay alone is not enough to determine if the defect resulted in a chip kill (non-recoverable failure), or just a chip failure that was repaired with the array redundancy. APRC data provides a detailed breakdown of the electrical signatures that cause imperfect arrays, but alone it provides no weighting to yield loss and does not provide any direction in terms of the physical mechanisms that drove the failure. WFT sort information allows us to quantify yield loss, but does not provide the insight necessary to determine the electrical or physical mechanisms that drove that loss.

Embodiments of the invention statistically calculate the kill rate for different APRC signals, and provide a determination of which APRC signal caused the chip to fail when there are multiple APRC calls associated with a single chip. From this statistical data, a projection with high confidence is made of the killer APRC call on each chip, which facilitates the creation of a weighted APRC pareto for both killer defects and fixable defects. The ETPLY data provides for the generation of a physical pareto of defects by APRC category. Merging the ETPLY physical pareto with the electrical yield weighted APRC pareto facilitates the calculation of yield loss by physical mechanism, which is the unified message the process engineering community needs to generate actions and improve array yield in a timely and efficient manner.

The first portion of the methodology of embodiments of the present invention involves analyzing volume WFT data, and the calculation of the limited yield (LY) for the array tests, which are normally a significant portion of loss in semiconductor device testing. Once the LY has been calculated for the WFT array sort loss, the APRC paretos are then analyzed to determine the different array fail modes observed at WFT. The kill ratio calculations are used to determine which APRC call is the “killer” when multiple APRC calls are present on a single chip. With the APRC pareto distribution and the WFT LY, the yield loss is apportioned among the different APRC categories to come up with a LY for each bucket, that provides an electrical weighting for the different array loss signals at WFT. The final step in the process involves accumulating array ETPLY data, PLY overlays with WFT BFMs (bit fail maps) with APRC data. Once the ETPLY breakout has been carried out for all of the APRC paretos, and yield loss is assigned from the WFT analysis, a calculation of product based defect LYs for all of the ETPLY categories is made. The weighting of the PLY observed defects, which is something that the semiconductor industry has historically struggled with, is improved with embodiments of the invention. Embodiments of the invention provide a more accurate and reliable method for prioritizing defects with a weighted pareto of ETPLY defects that are be utilized by manufacturing engineers.

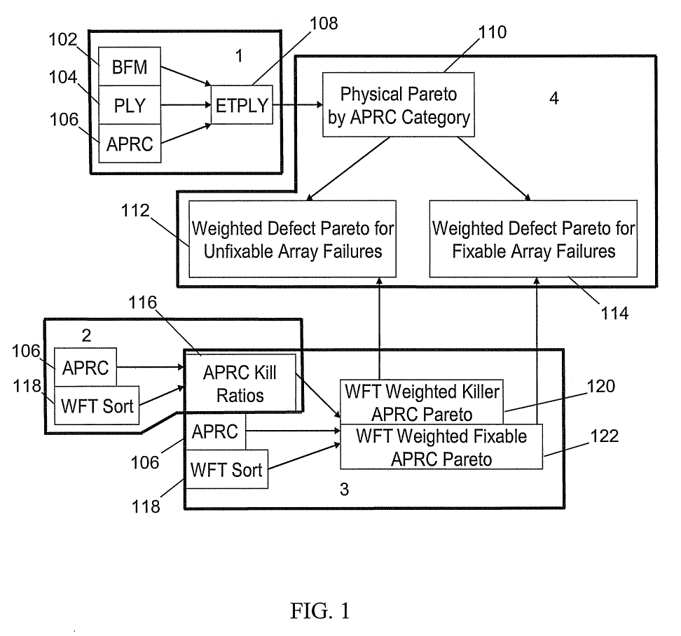

FIG. 1 is a flow diagram that outlines the methodology for creating array defect paretos using electrical overlay of bitfail maps (ETPLY), photo limited yield (PLY), yield, and auto pattern recognition code (APRC) data. The flow diagram is divided into four areas. In area 1, the bitfail map data (BFM) 102 is merged with inline photo inspection (PLY) data 104 with auto pattern recognition code (APRC) 104 to create a dataset of electrical fails along with the inline photo inspection defects that caused the electrical fails (ETPLY) 106. In area 2, the merging of APRC for array fails 106 with wafer final test (WFT) sort data 118 delineates array fails that are repairable from array fails that are more likely to cause chip kills. Calculating kill ratios for APRC codes 116 allows for the statistical calculation of the probability of failure for a given array failure signature. Merging APRC data 106 from wafer final test data with wafer final test sorts 118 provides for the development of a pareto of APRC codes for chips that were array fails 120, as well as, for chips that were repairable at wafer final test 122, and therefore were good chips that could be sold to the customer. In many instances, chips have multiple APRC calls per chip, because there were either multiple chip killing array failures, or there were both array failures that caused the chip failures and array fails that were fixable, and would have allowed for a good chip had the other array fails not been present. Merging the kill ratio data created in area 2 provides for the determination from the multiple APRC calls which of the APRC codes were most likely to cause the chip failure.

The steps in area 3 facilitate the creation of a weighted APRC pareto that quantifies the yield loss associated with each different APRC call 120. The merging of APRC kill ratios, APRC, and WFT sort data facilitates the creation of a weighted pareto for APRC calls that caused array failure, but were fixable through array redundancy 122. Merging these weighted electrical paretos (120, 122) with the ETPLY data 108 that correlates physical inline photo defects 104 with APRC fail signatures 106, facilitates the creation of a weighted defect pareto 110 in area 4. The weighted defect pareto 110 allows for the quantification of array yield loss 112 associated with each physical defect mechanism observed at PLY, and also facilitates the creation of a weighted pareto of defects observed at PLY that caused array fails, but were fixable via the array redundancy 114.

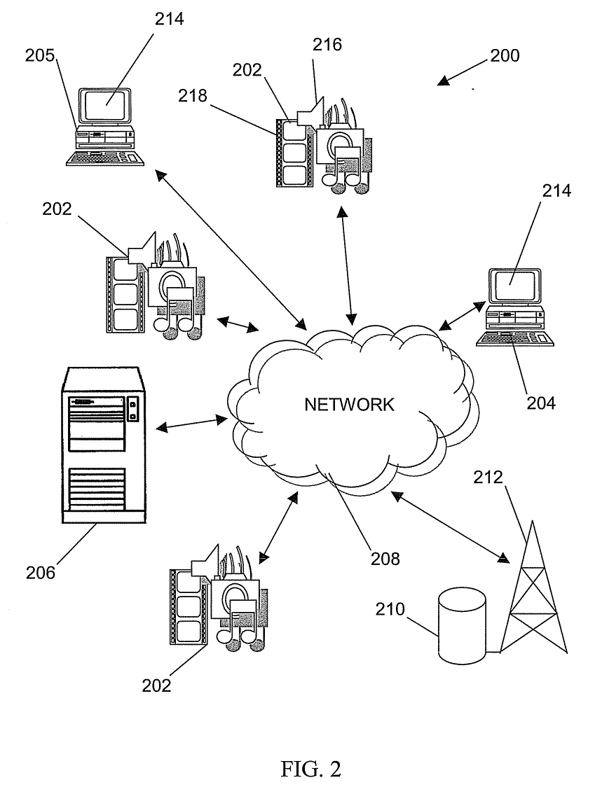

FIG. 2 is a block diagram of an exemplary system 200 for implementing an algorithm for creating array defect paretos using electrical overlay of bitfail maps (ETPLY), photo limited yield (PLY), yield, and auto pattern recognition code (APRC) data in semiconductor manufacturing. The system 200 includes remote devices including one or more multimedia/communication devices 202 equipped with speakers 216 for implementing the audio, as well as display capabilities 218 for facilitating graphical user interface (GUI) aspects for conducting statistical analysis of the manufacturing data with the method of the present invention. In addition, mobile computing devices 204 and desktop computing devices 205 equipped with displays 214 for use with the GUI of the present invention are also illustrated. The remote devices 202 and 204 may be wirelessly connected to a network 208. The network 208 may be any type of known network including a local area network (LAN), wide area network (WAN), global network (e.g., Internet), intranet, etc. with data/Internet capabilities as represented by server 206. Communication aspects of the network are represented by cellular base station 210 and antenna 212. Each remote device 202 and 204 may be implemented using a general-purpose computer executing a computer program for carrying out the GUI described herein. The computer program may be resident on a storage medium local to the remote devices 202 and 204, or maybe stored on the server system 206 or cellular base station 210. The server system 206 may belong to a public service. The remote devices 202 and 204, and desktop device 205 may be coupled to the server system 206 through multiple networks (e.g., intranet and Internet) so that not all remote devices 202, 204, and desktop device 205 are coupled to the server system 206 via the same network. The remote devices 202, 204, desktop device 205, and the server system 206 may be connected to the network 208 in a wireless fashion, and network 208 may be a wireless network. In a preferred embodiment, the network 208 is a LAN and each remote device 202, 204 and desktop device 205 executes a user interface application (e.g., web browser) to contact the server system 206 through the network 208. Alternatively, the remote devices 202 and 204 may be implemented using a device programmed primarily for accessing network 208 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for creating defect array paretos for semiconductor manufacturing, the method comprising:
merging a set of ETPLY data {the electrical overlay of bitfail map (BFM) data with inline photo inspection (PLY) data), and auto pattern recognition code (APRC) failure data to create an electrical failure data set along with a set of inline photo inspection defects that caused electrical failures;
merging the APRC failure data with wafer final test (WFT) sort data to delineate array failures that are repairable from array failures that are not repairable for the calculation of kill ratios;
wherein the merging of the APRC failure data with the WFT sort data is used to create paretos of APRC codes that are array failures that are not repairable; and
wherein the merging of the APRC failure data with the WFT sort data is used to create paretos of APRC codes for semiconductor devices that are repairable at wafer final test.

2. The method of claim 1, wherein the calculation of kill ratios facilitates the statistical calculation of the probability of failure for a given APRC code.

3. The method of claim 1, wherein the merging of the paretos of APRC codes for array failures that are not repairable with the set of ETPLY creates a weighted defect pareto for unfixable array failures; and
wherein the weighted defect pareto for unfixable array failures provides a quantification of array yield loss associated with each physical defect mechanism observed during PLY.

4. The method of claim 1, wherein the merging of the paretos of APRC codes for semiconductor devices that are repairable at wafer final test with the set of ETPLY creates a weighted defect pareto for fixable array failures; and
wherein the weighted defect pareto for fixable array failures provides a quantification of physical defect mechanisms observed during PLY that caused array failures, but were fixable via a redundancy in the array.

5. A system for creating defect array paretos for semiconductor manufacturing, the system comprising:
a set of hardware and networking resources;
an algorithm implemented on the set of hardware and networking resources;
wherein the algorithm merges a set of ETPLY data {the electrical overlay of bitfail map (BFM) data with inline photo inspection (PLY) data), and auto pattern recognition code (APRC) failure data to create an electrical failure data set along with a set of inline photo inspection defects that caused electrical failures;
wherein the algorithm merges the APRC failure data with wafer final test (WFT) sort data to delineate array failures that are repairable from array failures that are not repairable for the calculation of kill ratios;
wherein the merging of the APRC failure data with the WFT sort data is used to create paretos of APRC codes that are array failures that are not repairable; and
wherein the merging of the APRC failure data with the WFT sort data is used to create paretos of APRC codes for semiconductor devices that are repairable at wafer final test.

6. The system of claim 5, wherein the calculation of kill ratios facilitates the statistical calculation of the probability of failure for a given APRC code.

7. The system of claim 5, wherein the merging of the paretos of APRC codes for array failures that are not repairable with the set of ETPLY creates a weighted defect pareto for unfixable array failures; and
wherein the weighted defect pareto for unfixable array failures provides a quantification of array yield loss associated with each physical defect mechanism observed during PLY.

8. The system of claim 5, wherein the merging of the paretos of APRC codes for semiconductor devices that are repairable at wafer final test with the set of ETPLY creates a weighted defect pareto for fixable array failures; and
wherein the weighted defect pareto for fixable array failures provides a quantification of physical defect mechanisms observed during PLY that caused array failures, but were fixable via a redundancy in the array.
